(19) United States
(12) Patent Application Publication
(10) Pub. No.: US 2011/0175835 A1
(43) Pub. Date: Jul. 21, 2011

(54) Method for Scanning Projective Capacitive Touch Panel, Storage Medium and Apparatus for Scanning Projective Capacitive Touch Panel

(75) Inventor: Wanqiu Wang, Singapore (SG)

(73) Assignee: TPK TOUCH SOLUTIONS (XIAMEN) INC

(21) Appl. No.: 13/009,847

(22) Filed: Jan. 19, 2011

(30) Foreign Application Priority Data
Jan. 21, 2010 (CN) 201010103956.6

(51) Int. Cl. G06F 3/041

(52) U.S. Cl. 345/173

(57) ABSTRACT

The present invention relates to a method for scanning a projective capacitive touch panel including: A. scanning each first-axis electrode arranged along a first-axis and each second-axis electrode arranged along a second-axis, then obtaining the first-axis electrode and the second-axis electrode whose self capacitance changes; B. detecting the mutual capacitance at each intersection between the first-axis electrode and the second-axis electrode whose self capacitance changes to determine whether the mutual capacitance changes, then the area where the mutual capacitance changes being taken as a touched area. The present invention also relates to a storage medium storing instructions of implementing above method and an apparatus that implements the above method.

### BACKGROUND OF THE INVENTION

This application claims the benefit of People's Republic of China Application No. 201010103956.6, filed on Jan. 21, 2010.

### FIELD OF THE INVENTION

The present invention generally relates to a capacitive touch panel, and more particularly, to a method for scanning a projective capacitive touch panel, a storage medium and an apparatus for scanning a projective capacitive touch panel.

### DESCRIPTION OF THE RELATED ART

Capacitive touch panels are divided into projective capacitive touch panels and surface capacitive touch panels.

The projective capacitive touch panel includes two layers of conductive electrodes orthogonally placed. One layer of conductive electrodes includes M (M≧1) first-axis electrodes parallelly arranged along a first-axis (electrode X). The other layer of conductive electrodes includes N (N≧1) second-axis electrodes parallelly arranged along a second-axis (electrode Y).

A conventional method to determine the position of the touch point is to scan all the M×N capacitances based on the fact that the position of the intersections in the electrode matrix can determine the position on the screen. As the size of the touch screen increases, a time period for scanning the electrode matrix becomes longer accordingly for the same scanning accuracy. For a 42-inch touch panel, if M is 170, N is 100 and the scanning time of each capacitance is 30 μs, the time period for scanning the electrode matrix is 170×100×30 μs=0.51 s In other words, the scanning frequency is 1/0.51=1.96 Hz. That is a very low scanning frequency, which will cause a delay in determining a touch point. If the touch panel is a multi-touch panel then the time delay will get worse leading to a loss of touch points.

Thus, it is desired to provide a method for scanning a projective capacitive touch panel that overcomes the above drawbacks of the conventional scanning method.

### SUMMARY OF THE INVENTION

In one aspect, a method for scanning a projective capacitive touch panel is provided including: A. scanning each first-axis electrode arranged along a first-axis and each second-axis electrode arranged along a second-axis, then obtaining the first-axis electrode and the second-axis electrode whose self capacitance changes; B. detecting the mutual capacitance at each intersection between the first-axis electrode and the second-axis electrode which electrodes' self capacitance changes to determine whether the mutual capacitance changes, then taking an area where the mutual capacitance changes as a touched area. Also provided are storage medium for storing instructions of implementing the above-described method and an apparatus that implements the above-described method.

Thus, by combining detecting self capacitance and mutual capacitance, the method of present invention can significantly reduce the scanning time and boost the scanning frequency while the scanning accuracy is also guaranteed in a large touch panel.

### BRIEF DESCRIPTION OF THE DRAWINGS

Skilled persons in the art will understand that the drawings, described below, are for illustration purposes only and do not limit the scope of the present invention in any way. It is appreciated that the quantity of the disclosed components could be more or less than what is disclosed unless expressly specified otherwise.

FIG. 1 shows a projective capacitive touch panel connecting to a controller according to the present invention;

FIG. 2 illustrates scanning the self capacitance of first-axis electrodes along a first-axis according to the present invention;

FIG. 3 illustrates scanning the self capacitance of second-axis electrodes along a second-axis according to the present invention;

FIG. 4 shows a single touch on a touch panel according to a first embodiment of the present invention;

FIG. 5 is a plan view of a single touch on a touch panel according to a preferred embodiment of the present invention;

FIG. 6 shows a double touch on a touch panel according to the first embodiment of the present invention;

FIG. 7 shows a view of one of the electrodes in FIG. 6;

FIG. 8 shows the touched area and ghost area in FIG. 6.

### DETAILED DESCRIPTION OF THE INVENTION

In accordance with the usual meaning of “a” and “the” in patents, reference, for example, to “an” electrode or “the” electrode is inclusive of one or more electrodes. In this application, the use of the singular includes the plural and vice versa unless specifically stated otherwise, for example, the term “mutual capacitance” includes singular and plural forms,. The section headings used herein are for organizational purposes only, and are not to be construed as limiting the subject matter described.

The detailed description of the present invention will be discussed in the following embodiments, which are not intended to limit the scope of the present invention, but still can be adapted for other applications. While drawings are illustrated in details, it is appreciated that the quantity of the disclosed components could be greater or less than disclosed, except those components with express restricting amount.

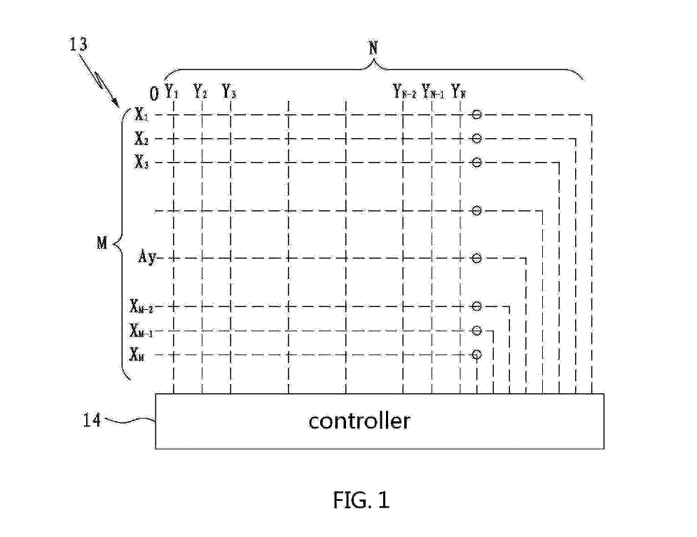

The method of the present invention is performed by a touch screen including a projective capacitive touch panel 13 and a controller 14, which is shown in FIG. 1, the controller 14 is electrically connected to the projective capacitive touch panel 13 to drive the projective capacitive touch panel 13. The projective capacitive touch panel 13 includes M first-axis electrodes parallelly arranged along a first-axis (defined as x-axis) and N second-axis electrodes parallelly arranged along a second-axis (defined as y-axis). The first-axis and the second-axis are orthogonal to each other. There are M+N self capacitances measured as relative to ground. There are also M×N mutual capacitance formed at intersections between the first-axis electrodes and the second-axis electrodes.

The method for scanning a projective capacitive touch panel includes the following steps:

A. scanning each first-axis electrode and each second-axis electrode to get the first-axis electrodes and the second-axis electrodes whose self capacitance change;
B. detecting the mutual capacitance at each intersection between the first-axis electrode and the second-axis electrode which electrodes' self capacitance changes to determine whether the mutual capacitance changes, then the area where the mutual capacitance changes being taken as a touched area.

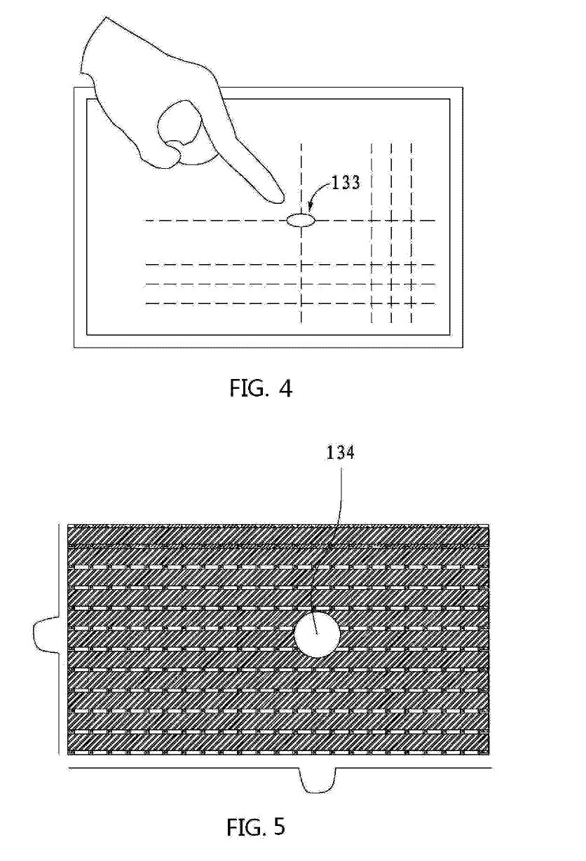

FIG. 4 shows a single touch on a touch panel according to a first embodiment of the present invention. A single touch affects the first-axis electrode(s) and the second-axis electrode(s) that pass through the touched area 133. In some embodiments, the width of the first-axis electrode or the second-axis electrode may be wider than the touched area 133, thus the single touch may only involves one first-axis electrode and one second-axis electrode. If changes of the self capacitance of the first-axis electrode and second-axis electrode are detected in the case of the single touch according to step A mentioned above, the position of a touch point can be determined by obtaining the x-coordinate (Xi, 1≦i≦M) of the first-axis electrode and the y-coordinate (Yj, 1≦j≦N) of the second-axis electrode. The mutual capacitance at the intersection between the first-axis electrode and the second-axis electrode is further detected to confirm the position of the touched area which has only one touch point.

In other embodiments, the touched area is generally wider than the width of the electrodes. FIG. 5 is a plan view of a single touch on a touch panel according to another embodiment of the present invention, the width of the electrodes is half of the touched area 134, thus the touched area 134 of the single touch affects two first-axis electrodes and two second-axis electrodes that pass through the touched area 134. There are four intersections having different coordinates located in the touched area, and a centroid can be further calculated according to the coordinates of the four intersections. Assuming that the x-coordinates of the touch-relevant first-axis electrodes are Xᵢ, Xᵢ₊₁(1≦i≦M−1), the voltage difference of the touched first-axis electrodes are Uᵢ, Uᵢ₊₁(1≦i≦M−1) respectively; the y-coordinates of the touch-relevant second-axis electrodes are Yᵢ, Yᵢ₊₁(1≦i≦N−1), and the voltage difference of the touched second-axis electrodes are Uⱼ, Uⱼ₊₁(1≦j≦N−1) respectively. The x-coordinates of the centroid is X=(Xᵢ×Uᵢ+Xᵢ₊₁×Uᵢ₊₁)/(Uᵢ+Uᵢ₊₁), and the y-coordinates of the centroid is Y=(Yⱼ×Uⱼ+Yⱼ₊₁×Uⱼ₊₁)/(Uⱼ+Uⱼ₊₁), then the position of the touch point is determined by the centroid (X,Y). In other embodiments, the single touch may involves more than two first-axis electrodes or two second-axis electrodes, and the calculation method of the centroid is similar to the above mentioned method.

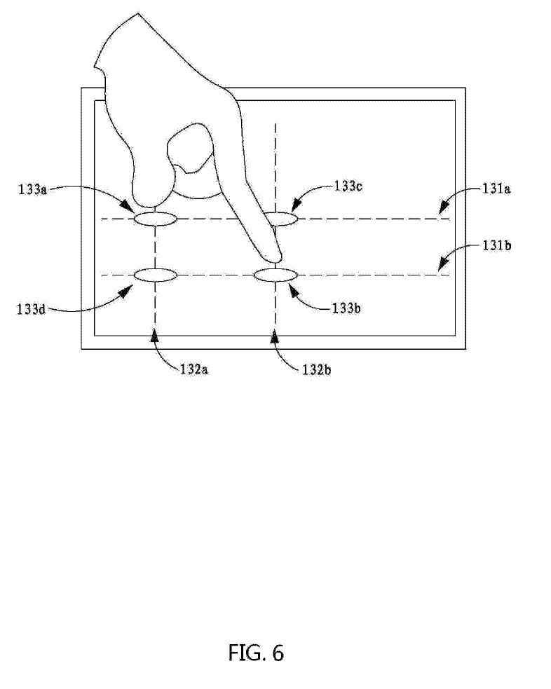

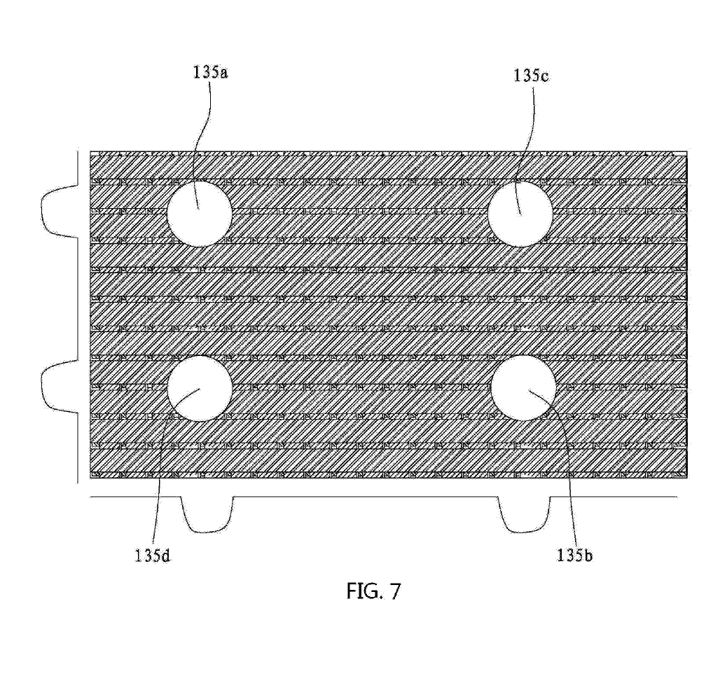

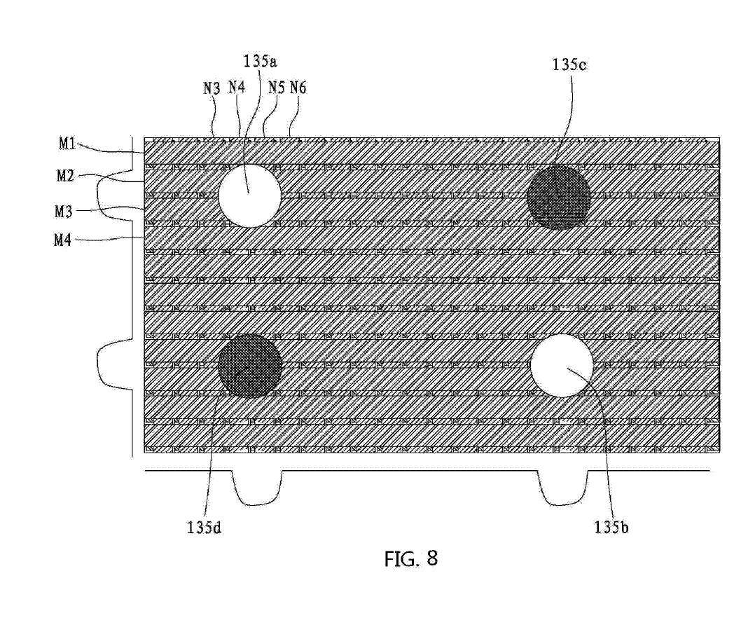

A more complicated situation is that there may be more than one touched area. A touch with more than one touched area will lead to forming ghost areas which are not really touched, but just a theoretically calculated result. If the ghost areas are not eliminated, they will be regarded as real touched areas in subsequent process, definitely causing fake locating. FIG. 6 shows a double touch on a touch panel according to another embodiment of the present invention. The touch-relevant first-axis electrodes and second-axis electrodes form intersections grouped in four areas 135a, 135b, 135c and 135d (as shown in FIG. 7), of which areas 135a and 135b are touched areas and areas 135c and 135d are ghost areas (as shown in FIG. 8). Since the ghost areas can not be recognized only by determining changes of the self capacitance of the first-axis electrodes and the second-axis electrodes, the mutual capacitance at the intersections in the areas 135a, 135b, 135c and 135d will be further detected to determine the touched areas 135a and 135b according to step B. And the touch points are determined by calculating the centroid of the touched areas.

According to the above embodiments, it needs to scan M+N+(p1×p2) times comparing to the conventional M X N times to get a touched area in a period of scanning, wherein M and N are the number of the first-axis electrodes and the second-axis electrodes respectively, p1 and p2 are the number of the touch-relevant first-axis electrodes and second-axis electrodes. When M and N are significantly greater than 2 and p1, p2 are very small, M×N is significantly greater than M+N+(p1×p2). In the case of a touch that two first-axis electrodes and two second-axis electrodes are involved, if M and N are both greater than 4, M×N will be greater than M+N30 2×2. In addition, if a touch involves 10 first-axis electrodes and 10 second-axis electrodes (this number is generally the maximum number of a multi-touch system can support), M and N are both much greater than 11 in most touch panel applications, thus M×N will be much greater than M+N+10×10.

The calculation for a 42-inch touch screen which has 170 first-axis electrodes and 100 second-axis electrodes is described in detail as follows: referring to FIG. 4, in the case of a single touch, only one first-axis electrode and one second-axis electrode are touched, scanning the 170 first-axis electrodes and 100 second-axis electrodes will immediately get the first-axis electrodes and second-axis electrodes whose self capacitance changes, and get the unique intersection 133, thus conclude the touch point. Each scanning costs about 30 μs, therefore the total scanning time in a scanning period is (170+100)×30 μs+1×1×30 μs=8.13 ms, that is, the scanning frequency is 123 frames per second, which is greater than the conventional 1.96 frames per second. Referring to FIG. 6, in the case of a double touch and each touch with only one first-axis electrode and one second-axis electrode being touched, two first-axis electrodes (131a, 131b) and two second-axis electrodes (132a, 132b) will be detected. The mutual capacitance at the four intersections will be detected according to step B, so the total scanning time in a scanning period is (170+100)+30 μs+2×2×30 μs=8.22 ms, that is, the scanning frequency is 121 frames per second, which is also greater than the conventional 1.96 frames per second.

It is obvious that the method for scanning a projective capacitive touch panel of the present invention can significantly reduce the scanning time and boost the scanning frequency while the scanning accuracy is also guaranteed for a large touch panel.

The process of obtaining the first-axis electrode and the second-axis electrode whose self capacitance changes according to step A includes more detailed steps as follows:

comparing a current self capacitance of each first-axis electrode and second-axis electrode with a preset reference self capacitance;
obtaining the first-axis electrode and the second-axis electrode whose current self capacitance satisfies a preset condition defined by a preset threshold value to be exceeded by the difference of the self capacitance to the preset reference self capacitance.

Self capacitance can be obtained by charging an electrode (first-axis electrode or second-axis electrode) to a preset capacitance and then connecting a reference capacitor to the electrode to charge the reference capacitor, the electrode will discharge and its voltage will decrease. The time that the voltage decreases to a preset voltage value can be measured and used to represent the self capacitance of the electrode.

There are two ways of setting the preset reference self capacitance of each first-axis electrode and second-axis electrode: the first way is directly writing the empirical value in the controller 14; the second way is getting an average value of multiple initial self capacitance correspondingly obtained from initialization scanning of the first-axis electrode and second-axis electrode repeatedly. Since each electrode has a preset reference self capacitance, there will be M+N preset reference self capacitance.

The initialization scanning includes: charging each of the first-axis electrode and second-axis electrode; discharging the reference capacitor connected to each of the first-axis electrode and second-axis electrode; obtaining the initial self capacitance of each of the first-axis electrode and the second-axis electrode according to the time of discharging when the discharging process is completed.

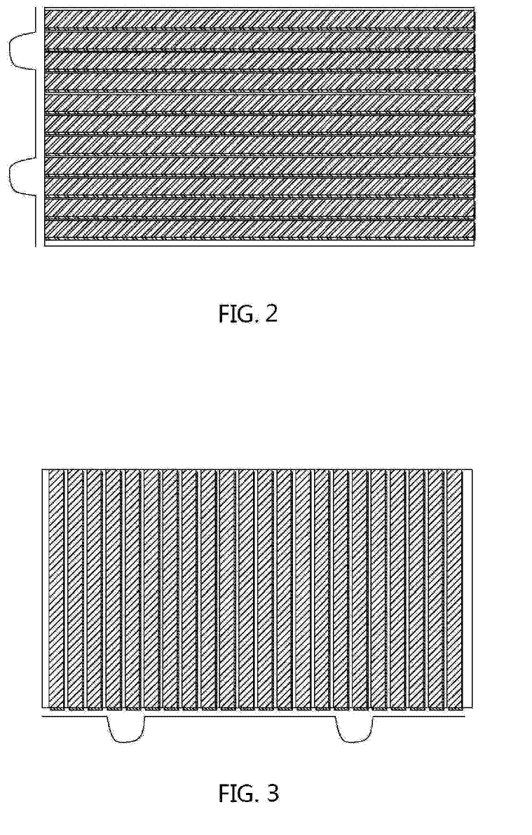

FIG. 2 illustrates scanning the self capacitance of first-axis electrodes along a first-axis according to the present invention. The controller 14 charges each first-axis electrode arranged along the first-axis (x-axis) and then discharge each of the first-axis electrode to the reference capacitor correspondingly connected to each of the first-axis electrode. When the discharging process of the first-axis electrode is completed, the current self capacitance of the first-axis electrode can be calculated. FIG. 3 illustrates scanning the self capacitance of second-axis electrodes along a second-axis according to the present invention. The current self capacitance of the second-axis electrode can be obtained by the same method.

The process of determining whether the mutual capacitance changes includes: comparing a current mutual capacitance at each intersection with a preset reference mutual capacitance at the intersection; obtaining the current mutual capacitance that satisfies a preset condition.

There are also two ways of setting the reference mutual capacitance at the intersections: the first way is directly writing the empirical value in the controller 14; the second way is calculating an average value of multiple initial mutual capacitance obtained from initialization scanning of the intersections repeatedly. Since there is a reference mutual capacitance for each intersection, there will be M×N preset reference mutual capacitance totally.

The initialization scanning includes: charging each second-axis electrode; collecting the electric charges induced in the first-axis electrode and converting the electric charges to voltage value, according to which obtain the initial mutual capacitance at each intersection. In an alternative embodiment, the first-axis electrode may be firstly charged.

The self capacitance or mutual capacitance may change in many situations, not only by touch, but also such as insufficient charge of the electrodes. In order to distinguish the capacitance change caused by a real touch or other events, the change of the current self capacitance or the current mutual capacitance should satisfy a preset condition. Generally, the preset condition is defined by a preset threshold value. For detecting the self capacitance, the difference of the self capacitance to the preset reference self capacitance must be greater than a corresponding preset threshold value, when this condition is satisfied, a touch on the electrode can be confirmed. Similarly, for detecting the mutual capacitance change, the difference of the current mutual capacitance to the reference mutual capacitance at an intersection must be greater than another corresponding preset threshold value, when this condition is satisfied, a touch on the intersection can be confirmed.

A storage medium is provided as well. The storage medium is used for storing a set of instructions capable of being executed by a processor to perform a method for scanning a projective capacitive touch panel. The method comprises:

A. scanning each first-axis electrode arranged along a first-axis and each second-axis electrode arranged along a second-axis, then obtaining the first-axis electrode and the second-axis electrode whose self capacitance changes;
B. detecting the mutual capacitance at each intersection between the first-axis electrode and the second-axis electrode whose self capacitance changes to determine whether the mutual capacitance changes, then taking an area where the mutual capacitance changes as a touched area.

A system for scanning a projective capacitive touch panel is also provided. The system includes a scanning module and a controlling module. The scanning module is used for detecting self capacitances of first-axis electrodes and second-axis electrodes. The controlling module is used for determining whether the self capacitances change and controlling the scanning module to detecting a mutual capacitance at an intersection between a first-axis electrode and a second-axis electrode if the self capacitance of the first-axis electrode and the second-axis electrode changes and determining a touched area defined by the intersection having a changed mutual capacitance.

While certain embodiments have been shown and described, various modifications and substitutions may be made thereto without departing from the spirit and scope of the invention. Accordingly, it is to be understood that the present invention has been described by way of illustration and not limitations.

What is claimed is:

1. A method for scanning a projective capacitive touch panel, comprising:
A- scanning each first-axis electrode arranged along a first-axis and each second-axis electrode arranged along a second-axis by a controller, then obtaining the first-axis electrode and the second-axis electrode whose self capacitance changes;
B- detecting mutual capacitance at each intersection between the first-axis electrode and the second-axis electrode which electrodes' self capacitance changes to determine whether the mutual capacitance changes, then area where the mutual capacitance changes being taken as a touched area.

2. The method according to claim 1, wherein the process of obtaining the first-axis electrode and the second-axis electrode whose self capacitance changes according to step A comprises:
comparing a current self capacitance of each of the first-axis electrode and the second-axis electrode with a preset reference self capacitance of the respective first-axis electrode and second-axis electrode;
obtaining the first-axis electrode and the second-axis electrode whose current self capacitance satisfies a preset condition.

3. The method according to claim 2, wherein the process of obtaining the current self capacitance comprises:
charging each of the first-axis electrode and the second-axis electrode;
discharging each of the first-axis electrode and the second-axis electrode to a reference capacitor correspondingly connected to the first-axis electrode and the second-axis electrode;
obtaining the current self capacitance of the first-axis electrode and the second-axis electrode when the process of discharging is completed.

4. The method according to claim 2, wherein the preset reference self capacitance of each of the first-axis electrode and the second-axis electrode is an average value of multiple initial self capacitance obtained from repeated initialization scanning of each of the first-axis electrode and the second-axis electrode correspondingly.

5. The method according to claim 4, wherein the initialization scanning comprises:
charging each of the first-axis electrode and the second-axis electrode;
discharging each of the first-axis electrode and the second-axis electrode to a reference capacitor correspondingly connected to each of the first-axis electrode and the second-axis electrode;
obtaining the initial self capacitance of each of the first-axis electrode and the second-axis electrode when the process of discharging is completed.

6. The method according to claim 2, wherein the preset condition is difference of the self capacitance to the preset reference self capacitance is greater than a preset threshold value.

7. The method according to claim 1, wherein the process of determining whether the mutual capacitance changes comprises:
comparing a current mutual capacitance at each intersection with a preset reference mutual capacitance at the intersection;
obtaining the area where the current mutual capacitance satisfies a preset condition.

8. The method according to claim 7, wherein the process of obtaining the current mutual capacitance comprises:
charging each of the second-axis electrode whose self capacitance changes;
collecting electric charges induced in the first-axis electrode and converting the electric charges to voltage value, according to which obtaining the current mutual capacitance at the intersection.

9. The method according to claim 7, wherein the preset reference mutual capacitance at the intersection is an average value of multiple initial mutual capacitance obtained from initialization scanning of the intersection repeatedly.

10. The method according to claim 9, wherein the initialization scanning comprises:
charging each of the second-axis electrode;
collecting electric charges induced in the first-axis electrode and converting the electric charges to voltage value, according to which obtaining the initial mutual capacitance at the intersection.

11. The method according to claim 7, wherein the preset condition is difference of the current mutual capacitance to the preset reference mutual capacitance at the intersection is greater than a preset threshold value.

12. The method according to claim 1 further comprising: calculating centroid of the touched area.

13. The method according to claim 1, wherein if the self capacitance of any of the first-axis electrode or the second-axis electrode does not change, repeat step A.

14. A storage medium for storing a set of instructions to perform a method for scanning a projective capacitive touch panel, the method comprising:
A- scanning each first-axis electrode arranged along a first-axis and each second-axis electrode arranged along a second-axis, then obtaining the first-axis electrode and the second-axis electrode whose self capacitance changes;
B- detecting mutual capacitance at each intersection between the first-axis electrode and the second-axis electrode whose self capacitance changes to determine whether the mutual capacitance changes, then area where the mutual capacitance changes being taken as a touched area.

15. A system for scanning a projective capacitive touch panel, comprising:
a scanning module for detecting self capacitances of first-axis electrodes and second-axis electrodes;
a controlling module for determining whether the self capacitances change and controlling the scanning module to detect a mutual capacitance at an intersection between the first-axis electrode and the second-axis electrode if the self capacitance of the first-axis electrode and the second-axis electrode changes and determining a touched area defined by the intersection having a changed mutual capacitance.
